(19) United States
(12) Patent Application Publication
(10) Pub. No.: US 2004/0098333 A1
(43) Pub. Date: May 20, 2004

(54) Administrative support system for a seller using an online auction site

(76) Inventor: Scott Meesseman, Warren, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/299,495

(22) Filed: Nov. 19, 2002

(51) Int. Cl. G06F 17/60

(52) U.S. Cl. 705/37

(57) ABSTRACT

The invention is an administrative support system and method (collectively “system”) for a seller using an online auction site. The system can allow sellers to generate and transmit auction related communications in an automated fashion, consistent with highly configurable predefined business rules. Such communications can be created from highly configurable predefined and reusable templates. Various highly configurable process checklists can be guide the automated transactions of the system. Redundant and manual activities can be minimized by maximizing the ability to capture and store information already entered by the seller or buyer. The system can interact with an online payment service to facilitate the collection of payment by the seller. Other forms of online services, such as shipment tracking, can also be integrated into the system.

### BACKGROUND OF THE INVENTION

The invention is an administrative support system and method (collectively the “system”) for a seller using an online auction site.

An increasing number of goods and services are being sold through online auctions. Web sites such as e-bay.com, priceline.com, and other online auction sites (collectively “online auction sites” or simply “auction sites”) are being used by a wide variety of different sellers and buyers to conduct a wide variety of different transactions.

Many online auction sellers (“sellers”) are businesses (“business sellers”). Some business sellers are traditional brick-and-mortar businesses seeking to augment sales by adding online auctions as one of many distribution channels. Online auctions can be an effective way for business sellers to sell excess inventory, especially in niche markets. The effectiveness of online auctions can permit some business sellers to rely on online auctions as their primary or even exclusive distribution mechanism.

Many sellers utilizing online auctions are not what would typically be referred to as businesses. Many sellers (“individual sellers”) are individuals without any affiliation to a company, partnership, or other form of business entity. Some individual sellers engage in relatively few transactions, such as the one-time sale of a stamp collection by a stamp collector. Other individual sellers can be involved in frequent transactions, such as a music enthusiast who frequently sells used compact discs.

Regardless of the type of seller, there are many hassles associated with selling goods and services on online auction sites. In online auction transactions, issues relating to award confirmation, taxes, delivery, payment, and other transaction activities are made more complex by the fact that the parties to the transaction are not involved in a face-to-face or even voice-to-voice interaction. A communication confirming the winning bid needs to be sent to the winning bidder. Shipping charges and sales taxes may need to be calculated. Invoices may need to be sent out, and a mechanism for receiving payment must be defined. These activities can consume substantial amounts of time and money, whether the seller is a business seller or an individual seller.

It would be desirable for a post-auction administrative support system to be usable from a stand alone computer of the type commonly used by individual sellers and small business sellers. It would be desirable if the programming logic for the system could in its entirety, be easily downloaded from a website and installed on the stand alone computer. The prior art lacks an effective tool that can be utilized by a wide variety of different sellers, including individual sellers and small business sellers, to efficiently, economically, and effectively provide automated post-auction administrative support. The prior art known to the inventor affirmatively teaches away from such a system.

It would be desirable for a post-auction administrative support system to maximize opportunities for automation and minimize the need sellers to engage in data input activities. Online auction sites require sellers to manually copy and paste such basic information as name, address, purchased item, and other transaction data. Existing systems do not support the ability of sellers to create highly configurable predefined business rules, including communication templates and process checklists, that can be automatically enforced by the system. The existing art known to the inventor affirmatively teaches away from such automation functionality.

### SUMMARY OF INVENTION

The invention is an administrative support system and method (collectively “system”) for a seller using an online auction site.

The system can allow sellers to generate and transmit auction related communications in an automated fashion, consistent with highly configurable predefined business rules. Such communications can be created from highly configurable predefined and reusable templates. Various highly configurable process checklists can be guide the automated transactions of the system.

Redundant and manual activities can be minimized by maximizing the ability to capture and store information already entered by the seller or buyer. The system can capture all relevant information from the online auction site with a single seller action, or in an automated fashion. The system can interact with an online payment service to facilitate the collection of payment by the seller. Other forms of online services, such as shipment tracking, can also be integrated into the system.

The system can use an input subsystem for capturing information relating to the auction, including any information potentially relating to the seller, the buyer, the transaction itself, or information useful to fulfilling the transaction (collectively “bid characteristics”). Redundant data entry activities can be eliminated, along with the inaccuracies and mistakes that commonly result from such activities.

The system can use a communication subsystem for automatically generating and transmitting communications from the seller to the buyer, using predefined templates, business rules, checklists, and/or profiles, such as buyer or seller profiles.

Various aspects of the invention will become apparent to those skilled in the art from the following detailed description of the preferred embodiment and the drawings described briefly below.

### BRIEF DESCRIPTION OF THE DRAWINGS

Some of the various features, advantages, uses, and characteristics of the present invention can become more apparent by referring to the following description and drawings.

FIG. 1 is a partial process flow diagram illustrating one example of a process flow beginning with the initiation of an online auction and ending with a successful bid.

FIG. 2 is a partial process flow diagram continuing where the process flow in FIG. 1 ended, illustrating one example of a process flow beginning with the identification of the successful bid and ending with the, appropriate communications and responses being sent to the bidder.

FIG. 3 is a block diagram illustrating one example of a subsystem-level view of the system.

FIG. 4 is a block diagram illustrating another example of a subsystem-level view of the system.

FIG. 5 is a block diagram illustrating an example of a module-level view of the system.

FIG. 6 is a flow chart illustrating one example of the processing that can be performed by the system.

FIG. 7 is a flow chart illustrating another example of the processing that can be performed by the system.

### DETAILED DESCRIPTION

The invention is an administrative support system and method (collectively the “system”) for a seller using an online auction site. A person of ordinary skill in the art would realize, however, that certain modifications would come within the teachings of this Invention, which must be studied to determine the true scope and content of the invention. In addition, the methods and structures of the present invention can be incorporated in the form of a variety of different embodiments, only a few of which are described herein. It will be apparent to the artisan that other embodiments exist that do not depart from the spirit of the invention. Thus, the described embodiments are illustrative and should not be construed as restrictive.

I. Introduction of Elements and Definitions

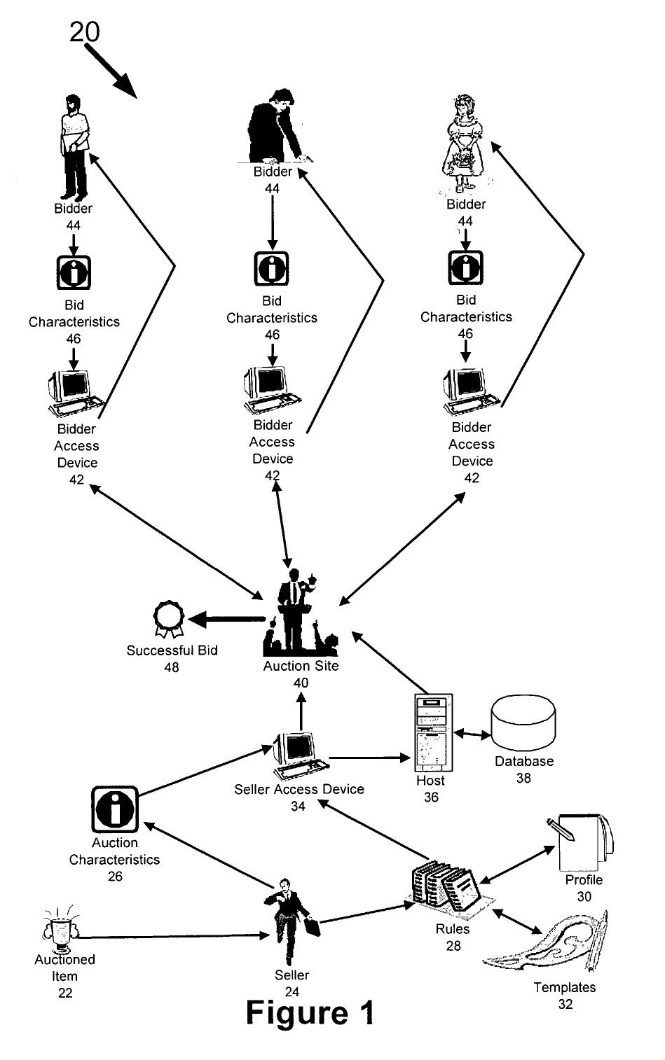

FIG. 1 is a multi-threaded process flow diagram illustrating one example of an administrative support method and system (the “system”) 20. The system 20 can be incorporated into a wide variety of different technical and business environments.

A. Auctioned Item and Item Characteristics

An auctioned item 22 can be any good, service, intangible, or other form of contractual consideration (collectively “auctioned item” 22 or simply the “item” 22) capable of being auctioned on an online auction site 40. The auctioned item 22 can possess numerous potentially relevant attributes (collectively “item characteristics”) which describe the item 22. Item characteristics can include: structural measurements such as height, width, or weight (collectively “structural item characteristics”); time related attributes such as age or expected life expectancy (collectively “temporal item characteristics”); functionality related attributes such as the ability of computer software to perform voice recognition, record compact discs, or connect to the Internet (collectively “functional item characteristics”); technical specifications such as hardware configurations, software compatibility or industry standards (collectively “item specification characteristics”); business characteristics such as purchase price, warranty, and other financial attributes (collectively “item business characteristics”); classification attributes such as consumer electronics, hair products for women, and automobiles (collectively “item type characteristics”); organization related attributes such as a manufacturer or retailer (collectively “organization-based item characteristics”); and other categories of item characteristics. Different embodiments of the system 20 can place different emphasis on different aspects of the item 22.

The auction of the item 22 does not necessarily mean that the item 22 is to be sold on the auction site 40. Items 22 processed by the system 20 can be donated, borrowed, leased, rented, licensed, purchased on a rent-to-own basis, transferred on a consignment or bailment basis, or conveyed in any other way (collectively “transactions”) that a transaction can occur on an online auction site 40.

B. Seller and Seller Characteristics

A seller 24 is the person, family, company, partnership, government agency, non-profit organization, community group, or any other organization or entity (collectively the “seller” 24) auctioning the item 22 on the auction site 40. Sellers can also include robots, computers, or online agents using artificial intelligence devices, expert systems, neural networks and other types of intelligent technologies (collectively “intelligent devices”).

As discussed above, an auction item 22 is not limited to an item to be sold at auction. Thus, “sellers” 24 are not limited to transactions involving “sales.” The seller 24 can also be referred to as the “actioning entity” 24 or “item provider” 24.

Each seller 24 can have a wide variety of different attributes (“seller characteristics”) that may be useful with respect to system 20 processing. Seller characteristics can relate to: business affiliations of the seller 24 (“seller business characteristics”); financial attributes such as income, debts, assets, or wealth creation (“seller financial characteristics”); inventory attributes such as the different number and types of owned items 22 (collectively “seller inventory characteristics”); past auctioning behavior (“seller auction history characteristics”); communication attributes such as e-mail addresses, mailing addresses, fax numbers, and pager numbers (collectively “seller contact characteristics” or “seller location characteristics”); and other types of seller characteristics. Different embodiments of the system 20 will process different numbers and types of seller characteristics.

C. Auction Characteristics

In approaching the online auction site 40 to facilitate the auction of the item 22, the seller 24 submits one or more auction characteristics 26 to the auction site 40. Certain auction characteristics 26 may be required by the auction site 40. In some embodiments, the system 20 is post a pre-auction and post-auction support system 20. In embodiments providing pre-auction support, the system 20 can be configured to automatically input relevant data to the auction site 40.

Some auction characteristics 26 may be useful to the auction site 40, but are not required. Other auction characteristics 26 may be useful to the system 20 in performing the administrative support functions, but are not required by the auction site 40. The system 20 can capture and store auction characteristics 26 for a variety of different reasons and purposes.

Auction characteristics 26 can include potentially all item characteristics and all seller characteristics. Auction characteristics 26 can also include attributes particular to the auction itself, such as the terms upon which an item 22 is being offered up for auction. Examples of such auction characteristics 26 can include auction floor prices (if the auction price fails to reach a minimum of $X, the transaction is not completed), desired auction prices, minimum increments for bidding, auction methodology such as the method of bidding, and any other attribute related to the auctioning of the item 22. Attributes relating to bids (e.g. bid characteristics 46 which are described below) can also constitute auction characteristics.

D. Seller Access Device

An access device 34 is any device by which the seller 24 can interact with the system 20. In many embodiments, the access device 34 is an electronic or computational device such as a stand-alone desktop or laptop computer with the ability to access the Internet and the World-Wide Web (collectively the “Web”). Mainframe computers, laptop computers, work stations, pagers, mini-computers, cell phones, personal digital assistants (PDAs), programmable logic devices, embedded computers, cable TV and satellite TV interfaces that allow access to the Web, and other communication devices can function as access devices.

The various access devices 34 used with the system 20 are connected to the auction site 40 by some form of network or other connection. In a preferred embodiment, the connection is the Web. In other embodiments, the network can be an intranet, an extranet, a local area network (LAN), a wide area network (WAN), a wireless network, a phone line, a radio transmission, or some other form of network or connection (collectively “network”).

The seller 24 accesses the system 20 through an access device 26 that can be referred to as a seller access device 34. An access devices used by a bidder 44 can be referred to as a bidder access device 42. The system 20 can incorporate a wide range of different seller access devices 34 and bidder access devices 42. In some embodiments, a single physical device can serve as both the bidder access device 42 and the seller access device 34.

E. Rules

In order to promote efficient processing, the system 20 can incorporate highly flexible and highly customizable process rules. These rules can be referred to as set of predefined processing rules, processing rules, or simply the “rules” 28. The seller 24 is able to create, update, and delete rules 28 that are capable of being automatically enforced by the system 20. The rules 28 are the means by which the system 20 permits automation of processes that would otherwise be performed in a manual fashion.

Rules 28 can relate to virtually any aspect of processing by the system 20. For example, the rules 28 can govern the automatic creation and transmission of communications to bidders 44. The substance, purpose, frequency, and format of follow-up communications can be controlled or at least influenced by the rules 28. Different communications can be sent out according to the financial value of the item 22; whether or not the successful bidder 44 is a repeat customer in good standing; or whether the bidder's payment is already past due.

By way of further example, post-auction activities can be automatically defined, scheduled, configured, and formatted pursuant to the rules 28. Some embodiments can be configured to automatically ship the item 22 and track the shipment of the item 22 without human intervention. Calculations of taxes, shipping charges, and other fees can be performed in accordance with predefined rules 28. Payments can be received electronically, and deposited electronically to the appropriate bank account.

The number and variety of different communications, post-transaction activities, and other system 20 processes that can be initiated, formatted, controlled, modified, shaped, and halted by the application of the rules 28 to various characteristics processed by the system 20 is potentially limitless. Rules 28 can also distinguish between a wide variety of characteristics, including auction characteristics 26 and bid characteristics 46 (described below). The system 20 can support a wide range of different rules 28. Each embodiment can be highly customized as desired by the sellers 28.

In some embodiments of the system 20, distinct categories of rules 28 can be supported by the system 20. In those embodiments, the categories of rules 28 can include entity-based or user-based profile (e.g. a “profile” 30), a checklist 31 of processes including pre-requisite and triggering events, and a library of communication templates (e.g. a “template” 32) for automatically generating communications.

1. Profile

A profile 30 is a type of rule 28. In a preferred embodiment, the system 20 has certain initial default rules and preferences which are automatically configured in accordance with the responses of the seller 24 to certain predefined questions. The seller's 24 responses to those questions can be used by the system 20 to create a profile 30 of the seller. The seller 24 can of course, be free to modify, erase, restart, shrink or expand their profile 30. The complexity of the profile 30 can be adjusted by the seller 24. For example, different sellers 24 will have business practices of differing complexity and scope. A seller 24 of five different categories of items 22 from three different locations will likely have profiles 30 of greater scope than an occasional seller 24 of a single category of items 22 from a single location.

A similar process can be used to create a bidder profile. For example, a bidder 44 may use different addresses for shipping purposes than for invoicing purposes. Bidder profiles can be created from both the bidder's 44 point of view as well as the seller's 24 point of view. For example, a bidder profile 30 from the seller's 24 point of view may be used to evaluate credit worthiness and reliability of the bidder 44. Examples of a bidder profile 30 from the bidder's 44 point of view could include the rules 28 of the bidder 44, including required billing practices from vendors and various address and contact information.

The profile 30 can be used to facilitate the creation of additional rules 28, because the system 20 can then have additional characteristics for differentiating different treatment and processes in different contexts. Rules 28 may also include checklists 31 of activities to be performed by the system 20.

2. Checklist

A checklist is a type of rule 28. In some embodiments of the system 20, the rules 28 include one or more checklists 31 that be used with respect to processing performed by the system 20. Checklists 31 can trigger system 20 processing after one or more triggering events occur within the system 20. For example, a checklist 31 can determine that bidders 44 with a poor payment history should receive a payment reminder two weeks after the transmission of an invoice. A separate checklist 31 can govern situations with bidders 31 exhibiting a positive payment history, with yet a third checklist 31 for new bidders 44 without any payment history. Checklists 31 can also determine the order in which the system 20 performs various processes.

Just as bidders 44 can be associated with profiles 30, bidders 44 can also be associated with checklists 31. For example, a large corporate entity may require different post-auction administrative processes than an individual bidder 44. The seller 24 could then create checklists 31 particular to the needs of that particular bidder 44. In some embodiments of the system 20, the business rules 28 of the seller 24 can automatically read, interact, and implement checklists 31 created by bidders 44.

3. Templates

A template 32 can be both a type of rule 28, and a method of implementing a rule 28. In some preferred embodiments of the system 20, the rules 28 can include one or more templates 32. Templates 32 can be communication templates 32 such as pre-made word processing documents or e-mail messages awaiting for the addition of address, name, and other bid characteristics to what is otherwise a boilerplate communication. Relevant auction characteristics 26 and bid characteristics 46 (described below) can then be plugged into the template 32 by the system 20 and used by the system 20 to create a communication 56. Templates 32 can also be used to structure post-transaction activities and other processes of the system 20.

The rules 28 of the system 20 permit substantial customization and sophistication. Different templates 32 can be invoked for contexts that differ with respect to merely one relevant characteristic.

F. Host and Database

A host 36 is a computational device that actually houses the programming logic and data (the “software”) used by the system 20 to perform its functions. In some embodiments, the host 36 is the same device as the seller access device 34. For example, a stand-alone computer with a Web browser can be both the host 36 and the seller access device 34. In a preferred embodiment, the software can be installed from either a CD-ROM, a floppy disk, or by downloading the software from the Web. The software can be sold to potential sellers 24 from a Web site.

In some embodiments, the host 36 is maintained by the seller 24. In other embodiments, an application service provider (ASP) manages the host 36 on behalf of one or more sellers 24. In still other embodiments, a bidder 44 can be responsible for managing the host 36. In some embodiments, the auction site 40 can be responsible for managing the host 36. In auction site 40 embodiments, the functionality of the system 20 can be integrated with the functionality of the auction site 40 in a seamless fashion.

In terms of the technology and programming techniques used to implement the software, a wide range of different techniques, approaches, and programming languages can be used. In a preferred embodiment, the software uses a graphical user interface (GUI) or web browser as an interface. It may be desirable to use a fully object-oriented programming language such as C++ or JAVA®), although 4^{th} generation languages such as VISUAL BASIC® can also be used.

The host 36 may include a database 38 or a connection to a database 38. The database 38 can be used to store all sorts of different information, including auction characteristics 26 and bid characteristics 46 (described below). By storing and analyzing such data, derived characteristics can be created by combining characteristics or performing various calculations. Such derived characteristics can be used by subsequently defined rules 28. For example, statistics can be obtained and stored relating to response times by successful bidders, the average length of time for payment, or other measurements and data. Sophisticated rules 28 could then differentiate between these various characteristics. In a preferred embodiment, the database 38 is either a relational database or an object-oriented database, although other databases, data structures, and storage techniques (collectively “databases”) can be used.

G. Auction Site

As indicated in FIG. 1, auction characteristics can be transmitted to an auction site 40 from the seller access device 34 or from the host 36. In a preferred embodiment, the auction site 40 is accessible from the Web (an “online auction site”). Examples of online auction sites include e-bay.com and priceline.com. In alternative embodiments, the auction site can be on a wide variety of different network-accessible locations as discussed above.

In some embodiments of the system 20, the auction site 40 is run by the same organization that runs the administrative support system 20. In other embodiments, different entities run the auction site 40 and the system 20.

Upon receipt of the auction characteristics 26, the auction site 40 notifies potential bidders 44 of the upcoming auction. Bidders 44 receive information about the auction through a bidder access device 42.

In most embodiments, the auction site 40 will be a different computational device than the host 36 or the seller access device 34. However, in some embodiments, a single device can serve as the auction site 40, the host 36, and the seller access device 34.

H. Bidders

A bidder 44 is any person, family, company, partnership, government agency, non-profit organization, community group, or any other organization or entity (collectively the “bidder” 44) placing a bid for the item 22 on the online auction site 40. Just as sellers 24 can be non-human entities and devices, bidders 44 can also include robots, computers, or online agents using artificial intelligence devices, expert systems, neural networks and other types of intelligent technologies (collectively “intelligent devices”).

As discussed above, an auction item 22 is not limited to an item to be sold at auction. Thus, bidders 44 are not limited to transactions involving “sales”. The bidder 44 can put in a bid on any type of transaction, and can even potentially make a bid with non-monetary consideration.

Due to space constraints, only three potential bidders 44 are shown in FIG. 1. However, the number of potential bidders 44 is limited only by the capabilities of the auction site 40.

I. Bid Characteristics

A bid is comprised of one or more bid characteristics 46. In submitting the bid to the auction site 40 through the bidder access device 42, one or more bid characteristics 46 are sent to the auction site 40. Bid characteristics 46 can include potentially all attributes relating to the bidder 44 and the bid made by the bidder 44. Examples of bid characteristics 46 can include a monetary bid value, identification of a payment mechanism, a type of currency, floor and ceiling bids, increments for increasing a bid automatically, or any other bid parameter or attribute (collectively “bid characteristics” 46).

Bid characteristics 46 can also include bidder-based attributes (“bidder characteristics”). Bidder characteristics can relate to: business affiliations of the bidder 44 (“bidder business characteristics”); financial attributes such as income, assets, or wealth creation (“bidder financial characteristics”); inventory attributes such as the different number and types of owned items 22 (collectively “bidder inventory characteristics”); past auctioning behavior (“bidder auction history characteristics”); communication attributes such as e-mail addresses, mailing addresses, fax numbers, and pager numbers (collectively “bidder contact characteristics” or “bidder locations”); and other types of bidder characteristics. Different embodiments of the system 20 will process different numbers and types of bidder characteristics.

J. Bidder Access Device

A bidder access device 42 is any access device (as defined above) that can be used by a bidder 44 to communicate with and access the auction site 40. A wide variety of different bidders 44 can use a wide variety of different bidder access devices 42 to participate in the same auction.

K. Successful Bid

The system 20 is highly adaptable and flexible with respect to the different ways in which an auction can be conducted. Regardless of the particular rules 28 of the particular auction, the system 20 can provide administrative support to the bidder 44. Thus, regardless of how a successful bid 48 is determined, the system 20 can be used to subsequently generate communications and activities based on a successful bid 48.

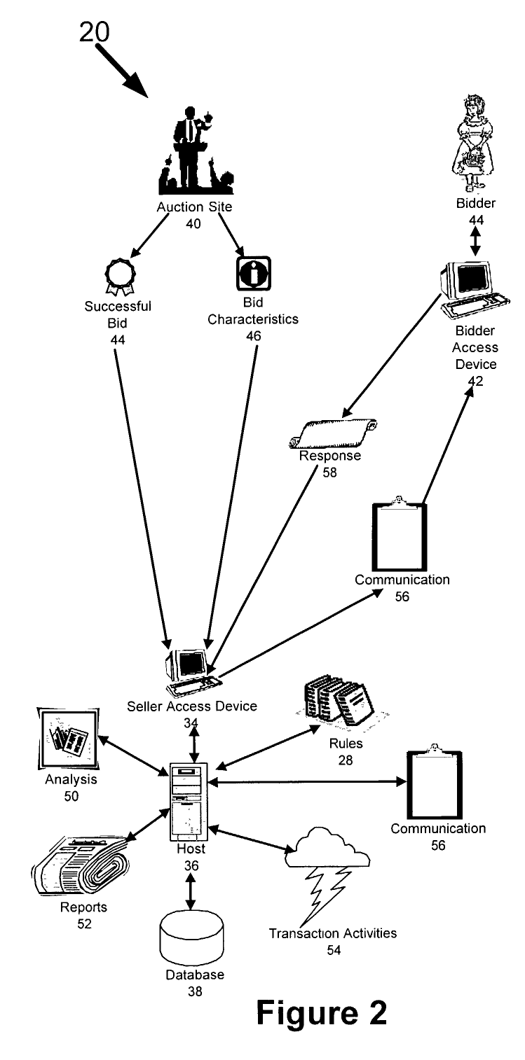

The process can then continue to the processing identified on FIG. 2. At the top of FIG. 2, the auction site 40 sends the successful bid 44 and the bid characteristics 46 relating to that successful bid 48 to the seller access device 34. In some embodiments, the bid characteristics 46 of unsuccessful bids are also sent to the seller access device 34 so that the seller 23 can build store and analyze the data for the purpose of maximizing its business activities and opportunities in the future.

L. Communication

The seller access device 34 receives the successful bid 48 and the bid characteristics 46. The successful bid 48 and bid characteristics 46 are sent to the host 36. The host 36 can then automatically generate and transmit communications 56 in response to the successful bid 48 and bid characteristics 46. The communication 56 can be any method of sending a message that can be initiated by a computer, such as e-mail (including electronic invoices), instant messaging, chat room posting, telephone calls, facsimiles, website content, printed materials, letters, radio communication, satellite communication, or any other mechanism for transmitting information or interacting with others (collectively “communication” 56).

Communications 56 can be generated in accordance with all of the programming logic housed in the host 36. The rules 28, including profiles 30, checklist 31, and templates 32, are housed and implemented in the host 36. Access to any information on the database 38 can be used by the software in the host 36. The host 36 can generate a report 52 or other type of analysis 50 that might be useful in generating or automatically generating a communication 56. In addition to creating communications 56, the host 54 can also generate a transaction activity 54, such as initiating a shipment of the item 22 or accepting a payment from an online payment service such as ®PAYPAL. The functionality of invoking transaction activities 54 can be performed in an automated fashion without human intervention in accordance with the rules 28. Transaction activities 54 can be related to communications 56, coincide with communications 56, or be totally distinct and unrelated to communications 56 generated by the system 20.

Communications 56 can also be transmitted automatically and without human intervention. For example, the e-mail address of the bidder 44 can be a bid characteristic 46. The system 20 can use that bid characteristic 46 to address the communication 56. Communications 56 can be accessed by the successful bidder 44 using the bidder access device 42. The bidder 44 can reply to the system 20 using the bidder access device 42 to generate a response 58.

M. Response

Just as the communication 56 described above can be in many different forms, the response 58 generated by the bidder 44 can also be in a wide variety of different forms. Although FIG. 2 discloses only one response 58, the system 20 anticipates that in many situations, there will be a series of communications 56 and responses 58. For example, an initial communication 56 may propose various delivery options to the bidder 44. The initial response 58 could reply with the desired delivery process. A subsequent communication 56 could request payment with the subsequent response 58 notifying the seller 24 of when payment would be forthcoming. There are numerous post-auction communications that are typically invoked by the system 20. The rules 28 of the system 20 can cause the system 20 to automatically generate communications 56 and transaction activities 54 in response to the response 58 by the bidder 44. Responses 58 can be electronic payments, including payments through third party online services such as ®PAYPAL.

Subsystem-Level View

A. Input Subsystem

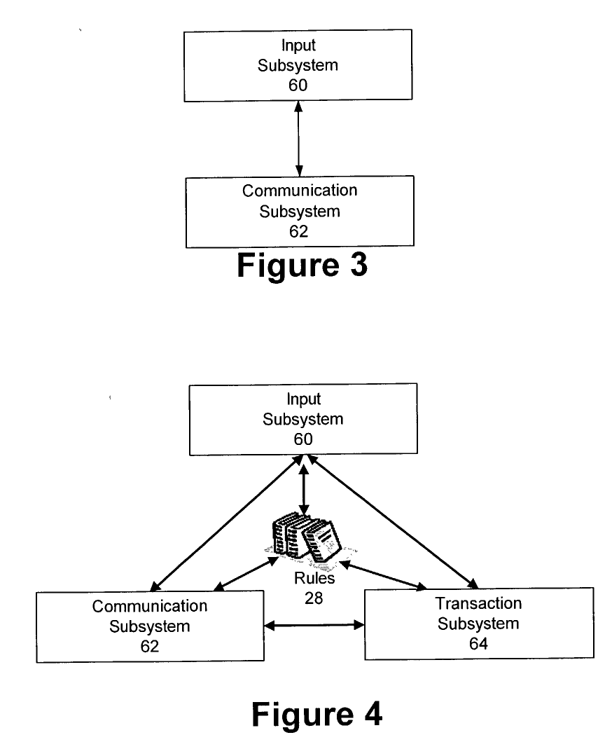

FIG. 3 is a block-diagram illustrating an example of subsystem-level view of the system 20. An input subsystem 60 can be configured to capture or receive one or more bid characteristics 46 from one or more bidders 44. In some embodiments, the input subsystem 60 can capture information from the auction site 40. This alleviates the need for the seller 24 to re-type information, or to cut and past information from the auction site 40. One of the bid characteristics 46 can be a bidder location. The bidder location can be in the form of an e-mail address, a fax number, a phone number, a mailing address, a pager number, a cell phone number, a web site, a chat room, or some other “location” for receiving communications 56. The input subsystem 60 can capture bid characteristics 46 for many different successful bids 48 and unsuccessful bids. As discussed above, each individual bid can have potentially numerous bid characteristics 46.

The input received by the input subsystem 60 from the seller 24 can be used to add, modify, or delete rules 28, including checklists 31, profiles 30, and templates 32. The input subsystem 60 can be housed exclusively in the seller access device 34 described above, or partially within both the seller access device 34 and the host 36.

The seller access device 34 can house the software used by the seller 24 to interface (e.g. the seller interface) with the system 20. The seller interface can be used by the seller 24 for data entry purposes, and to receive other forms of seller actions, such as the push of a button, the click of a mouse, the selection of an item in a drop down list box, etc. A single action can trigger the collection of bid characteristics 46 from the auction site 40. Seller 24 input can also be used to modify communications 56 generated by the system 20.

The software used to make the input subsystem 60 function can be downloaded from the Web. In such embodiments, the seller interface can also be downloaded from the Web. The input subsystem 60 can be configured to receive electronic payments from online payment services such as those offered at paypal.com.

B. Communication Subsystem

A communication subsystem 62 can be used to generate and transmit communications 56. In some embodiments, the rules 28, including checklists 31, templates 32, and profiles 30 are housed and enforced by the communication subsystem 62. The communication subsystem 62 can be configured to generate and transmit communications 56 in an automated fashion without human intervention. Communications 56 can be generated by modifying a template 32 using one or more of the bid characteristics 46. Communications 56 can be transmitted to the bidder 44 using one or more bid characteristics 46 such as a bidder location. Different forms of communications 56 (as described above) can be generated and transmitted by the system 20.

The communication subsystem 62 can generate many different communications 56 in a simultaneous or roughly simultaneous manner. A single response 58 or a single successful bid 44 can result in the generation and transmission of multiple communications 56. In some embodiments, the communication subsystem 62 can be downloaded from the Web and loaded onto a stand-alone computer.

C. Transaction Subsystem

FIG. 4 illustrates a different example of a subsystem-level view of the system 20. The embodiment disclosed in FIG. 4 includes not only the input subsystem 60 and the communication subsystem 62, but also includes a transaction subsystem 64. Some embodiments of the system 20 do not include a transaction subsystem 64.

The transaction subsystem 64 transforms bid characteristics 46 relating to the actual auction transaction into transaction characteristics, e.g. characteristics relating to the fulfillment of the transaction. The system 20 can generate transaction characteristics using bid characteristics 46 and auction characteristics 26, as well as responses 58 to communications 56. For example, the total cost of a transaction requires bid characteristics 46 such as bidder location and auction characteristics 22 such as seller location if the shipping cost and taxes are to be accurately calculated. Other examples of transaction characteristics include shipping information, a shipping address, a payment type, a shipper, an estimated time of arrival, a shipping service, and other transaction-related characteristics.

The transaction subsystem 64 can generate transaction activities 54 using bid characteristics 46, auction characteristics 26, responses 58, and other data as inputs. Transaction activities 54 can be selected and invoked in accordance with the rules 28, and can be invoked without human intervention in an automated fashion. Multiple transaction characteristics can be created from multiple bid characteristics 46. Transaction activities can be invoked by the system 20 taking into account both seller and bidder profiles 30.

In some embodiments, the software that supplies the functionality for the transaction subsystems 64 can be downloaded from the Web onto a stand-alone computer.

III. Module-Level View

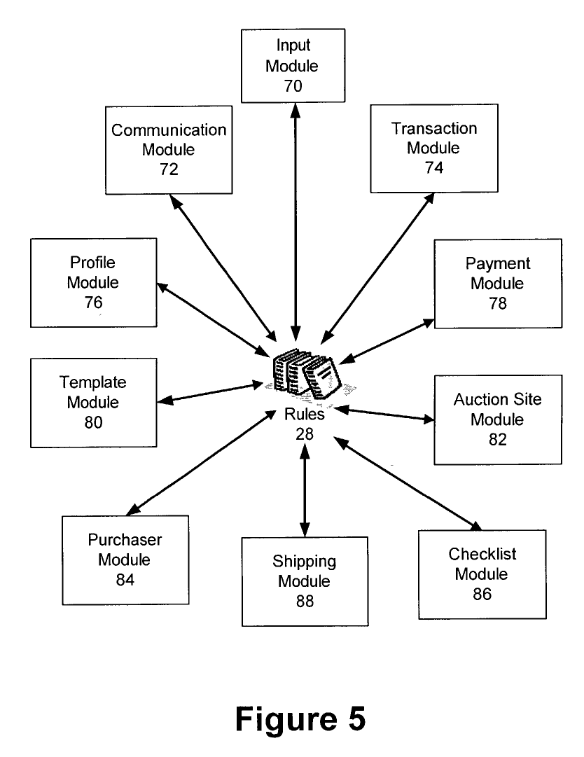

FIG. 5 is an example of a block diagram of a module-level view of the system 20. As indicated in the diagram, any module can interact with any other module in the system 20, limited only by the constraints of the rules 28.

A. Input Module

An input module 70 can perform all of the functions of the input subsystem 70. The input module 70 includes the seller interface, which can be used by the seller 24 to input data into the system 20 or react to other seller 24 interactions with the system 20.

B. Transaction Module

A transaction module 74 can perform all of the functions of the transaction subsystem 64. The transaction module 74 can automatically invoke transaction activities 54 based on the input received from the input module 70 using the rules 28, including predefined checklists 31.

C. Payment Module

A payment module 78 can be used by the system 20 to facilitate the receipt of electronic payments from services such as those offered by ®PAYPAL. The ability to receive payments electronically can be configured using the rules 28.

D. Auction Site Module

An auction site module 82 can be used in conjunction with the input module 70 to better capture data used by the auction site 40. The system 20 can benefit from integration or close cooperation with the auction site 40. The auction site module 82 can facilitate the exchange of information between the auction site 40 and the system 20, validating the accuracy of data if desired.

E. Checklist Module

To facilitate the creation, modification, and deletion of checklists 31, a checklist module 86 including a checklist interface can be used by the seller 24. In a preferred embodiment, the checklist interface is a graphical user interface that allows predefined events to be linked as triggering events or prerequisites for the automatic invocation of transaction activities 54 and communications 56.

F. Shipping Module

A shipping module 88 can be used by the system 20 to invoke shipment of an item 22 and to track the shipment of the item 22. In some embodiments, the shipping module 88 interfaces directly with the website of a shipping company involved in the transaction.

G. Purchaser Module

A purchaser module 84 can be used by the system 20 to build bidder-specific rules 28. For example, repeat bidders 44, especially large companies that are repeat bidders 44, may require and merit specific processing rules. The purchaser module 84 can facilitate the entry of such rules. The purchaser module 84 can also include a mechanism for obtaining additional information about a bidder 44, by either purchasing information such as a Dunn & Bradstreet report, or by automatically invoking an Internet search engine so that the seller 24 can view additional information about the bidder 44.

H. Template Module

A template module 80 is a mechanism by which the seller 24 creates templates 32 to be used by the system 20. In some embodiments, templates 32 can be medium-specific, i.e. e-mail templates being distinct from paper “snail mail” letters. In some embodiments, the template module 80 includes a word processing program.

I. Profile Module

A profile module 76 can be used to create, modify, and delete profiles 30. A single seller 24 can have multiple profiles 30 if desirable to represent different categories of activities pursued by the seller 24. The profile module 76 can incorporate various intelligence technologies to build a profile 30 in an automated fashion.

J. Communication Module

The communication module 72 can perform any of the functions performed by the communication subsystem 62.

IV. Process-Level Views

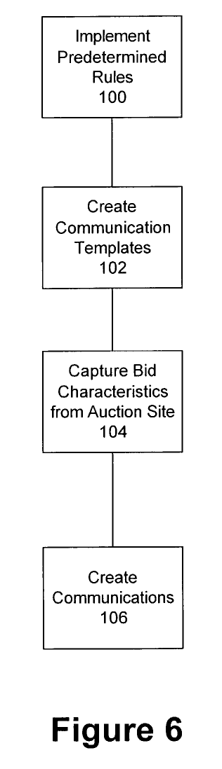

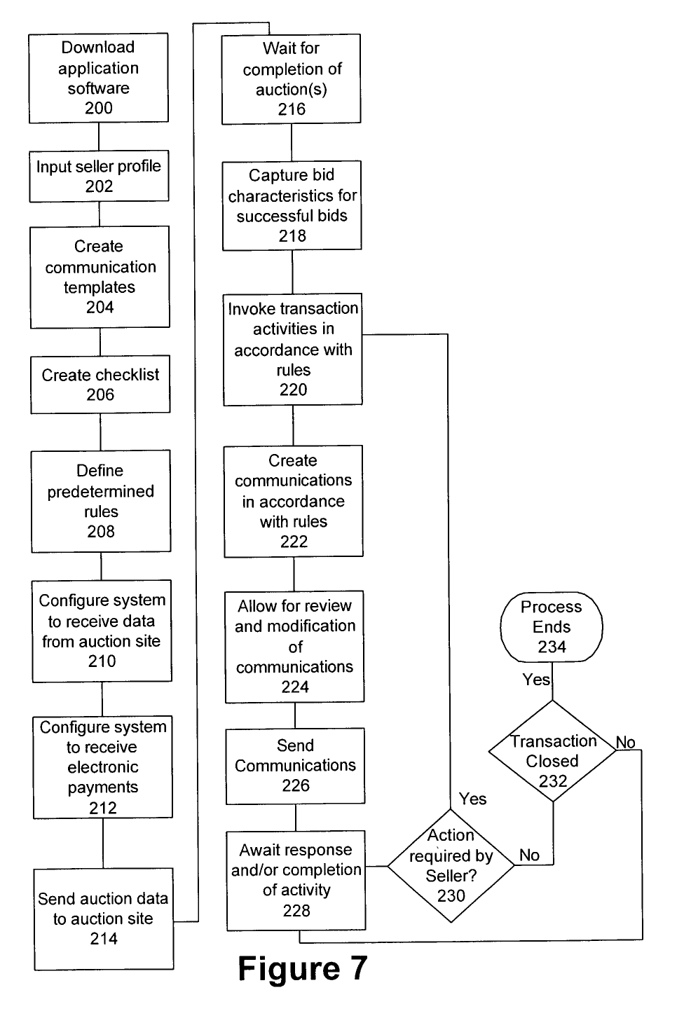

The system 20 can perform functions in a wide variety of different ways. FIGS. 6 and 7 provide two examples of processing that can be performed by the system 20.

A. Process Flow 1

In FIG. 6, the process begins with the implementation of predetermined rules 28 at 100. This step can be performed all at once during the implementation of the system 20, or rules 28 can be added, modified, or deleted at a later date as the user becomes more familiar with the capabilities of the system 20. During this step, the system 20 can be configured to automatically ask the seller certain questions in order to generate a seller profile 30.

Templates 32 can be created at 102. In some embodiments, the templates 32 can be created automatically in accordance to the rules 28 at 102. The system 20 can interface with various commercially available software products in order to create, modify, or delete templates 32.

At 104, bid characteristics 46 can be captured by the system 20 from the auction site 40 performing the auction. Based on those bid characteristics 46, the system 20 can create communications 56 using the business rules 28 and templates 32. A single action by the seller 24 such as a click of a mouse or other seller interface action, can result in the automatic capture and transport of data from the auction site 40 to the system 20.

At 106, communications 56 can be automatically generated by the system 20. Such communications 56 can be reviewed and modified by the seller 24 if that is desirable. Otherwise, the rules 28 allow the system 20 to generate and transmit communications 56 automatically without human intervention.

B. Process Flow 2

FIG. 7 is a different example of a process flow of the system 20. At 200, the seller 24 can download the software containing the programming logic in object code form to enable the functionality of the system 20. At 202, the seller 24 can input one or more seller profiles 30. Preferably, such profiles 30 are created by the seller merely answering questions posed by the system 20. Such questions can be dynamically selected, so that the answer to one question determines the next question that is asked.

At 204, communication templates 32 can be created or modified. At 208, the predefined rules 28 can be incorporated into the system 20 by the seller 24. The rules 28 can relate to templates 32 and profiles 30 previously created. At 210, the system 20 can be configured to receive data from the auction site 40. At 212, the system 20 can be configured to receive electronic payments. At 214, auction data can be sent to the auction site.

At 216, the seller 24 waits for the completion of one or more auctions. At 218, bid characteristics 46 are captured by the system 20 from the auction site 40. At 220, transaction activities 54 can be invoked by the system 20 in accordance to the rules 28. At 222, communications 56 can be created in accordance with the rules 28. At 224, the generated communications 56 can be reviewed by the seller 24 if desired. In other embodiments, the communications 56 can be transmitted automatically and without review by the seller 24. At 226, the communications 56 can be sent in a simultaneous or substantially simultaneous manner. At 228, the system 20 awaits a response 58 or completion of a transaction activity 54.

If at 230, action is required by the seller 230 in the form of a communication 56 or a transaction activity 54, those actions can be automatically invoked at 220. If no subsequent actions are required by the seller at 230, then the system 20 determines whether or not the transaction is completed at 232. If the transaction at 232 is completed, the process ends at 234. If the transaction at 232 is not completed, the system 20 returns to 228 awaiting a response 58 or completion of a transaction activity 54. Checklists 31, rules 28, communications 56, and/or responses 58 can all have an impact on the determination of whether the transaction is in fact closed at 232.

V. Alternative Embodiments

In accordance with the provisions of the patent statutes, the principles and modes of operation of this invention have been explained and illustrated in multiple preferred and alternative embodiments. However, it must be understood that this invention may be practiced otherwise than is specifically explained and illustrated without departing from its spirit or scope.

In the claims:

1. An administrative support system for a seller using an online auction site, comprising:
an input subsystem, including a plurality of bid characteristics, wherein said input subsystem is configured to retrieve said plurality of bid characteristics from the online auction site, and wherein said plurality of bid characteristics is configured to include a bidder location; and
a communication subsystem, including a template and a communication, wherein said communication subsystem is configured to generate said communication from said template and at least one said bid characteristic, and wherein said communication subsystem is configured to send said communication to said bidder location.

2. The system of claim 1, wherein said bidder location is an e-mail address, and wherein said communication is configured to be an e-mail that is automatically generated and sent without human intervention.

3. The system of claim 1, wherein said bidder location is a fax number, and wherein said communication is configured to be a notification letter that is automatically generated and sent without human intervention.

4. The system of claim 1, wherein said communication is configured to comprise at least two of an e-mail, a notification letter, a facsimile of a notification letter, a chatroom posting, a website listing, or an automated phone call.

5. The system of claim 1, wherein said input subsystem is configured to further include a plurality of successful bids;
wherein each successful bid in said plurality of successful bids is configured to include a plurality of bid characteristics affiliated with said successful bid;
wherein said communication subsystem is configured to further include a plurality of communications;
wherein each said communication in said plurality of communications is configured to be affiliated with one said successful bid;
wherein said communication subsystem is configured to generate at least one said communication for each said successful bid; and
wherein for each said successful bid, said communication subsystem is configured to send each said communication to said bidder location affiliated with said successful bid.

6. The system of claim 5, wherein said communication subsystem is configured to generate said plurality of communications in a substantially simultaneous manner.

7. The system of claim 5, wherein said communication subsystem is configured to send said plurality of communications in a substantially simultaneous manner.

8. The system of claim 1, said input subsystem being configured to further comprise a seller interface and a seller input, wherein said seller interface is configured to receive said seller input, and wherein said communication subsystem is configured to modify said template with said seller input.

9. The system of claim 8, said communication subsystem being further configured to comprise a set of predefined rules, wherein said template is configured to be modified in accordance with said set of predefined rules.

10. The system of claim 8, said input subsystem being further configured to comprise a set of predefined rules, wherein said set of predefined rules are configured to be modified with said seller input.

11. The system of claim 8, further comprising a stand-alone computer, wherein said input subsystem and communication subsystem are configured to reside on said stand-alone computer, and wherein the auction site does not reside on said stand-alone computer.

12. The system of claim 11, further comprising a web site, wherein said input subsystem and said communication subsystem are configured to be downloaded from said website to said stand-alone computer.

13. The system of claim 8, further comprising a stand-alone computer and a web server, wherein said seller interface is configured to reside on said stand-alone computer and wherein said communication subsystem is configured to reside on said web server.

14. The system of claim 1, further comprising a transaction subsystem, said transaction subsystem being configured to include a transaction activity and a set of predefined rules, and wherein said transaction subsystem is configured to automatically activate said transaction activity in accordance with said set of predefined rules.

15. The system of claim 14, wherein said transaction subsystem is configured to further include a plurality of transaction characteristics, where said transaction subsystem is configured to generate said plurality of transaction characteristics from said bid characteristics.

16. The system of claim 15, wherein said transaction characteristics include at least two of a shipping cost, a tax, a total cost, a shipping address, and a payment type.

17. The system of claim 1, wherein said communication is an electronic invoice.

18. The system of claim 17, wherein said input subsystem is further configured to include a electronic payment receiver and a response, and wherein said electronic payment receiver is configured to receive said response.

19. The system of claim 18, wherein said response is an electronic payment.

20. The system of claim 19, wherein said electronic payment is processed through a third party.

21. The system of claim 1, further comprising a plurality of bidder characteristics and a database, wherein a subset of bid characteristics are said plurality of bidder characteristics, and wherein said bidder characteristics are stored on said database.

22. The system of claim 21, further comprising a set of predefined rules, wherein said bidder characteristics are categorized by said set of predefined rules.

23. The system of claim 1, further comprising a set of predetermined rules, seller profile, a buyer profile, and a transaction activity, wherein said system is configured to automatically invoke said transaction activity in accordance with said seller profile, said buyer profile, and said set of predetermined rules.

24. An administrative support system for a seller at an online auction site, comprising:
an input subsystem, including:
a plurality of successful bids, wherein each successful bid in said plurality of successful bids comprises:
a plurality of bid characteristics, wherein said plurality of bid characteristics includes:
a successful bidder location;
a seller interface comprising a seller action, wherein said seller interface receives said seller action, triggering said input subsystem to receive said plurality of successful bids from the online auction site;
a set of predefined rules, including a plurality of communications rule and a plurality of transaction rules;
a communication subsystem, including a template and a plurality of communications,
wherein for each said successful bid, said communication subsystem generates at least one said communication from said template, at least one said communications rule, and plurality of bid characteristics belonging to said successful bid, and
wherein each said communications in said plurality of communications is sent to the successful bidder location attributed to said successful bid; and
a transaction subsystem, including a plurality of transaction activities, wherein for each successful bid, said transaction subsystem selectively invokes at least one said transaction activity in accordance with at least one said transaction rule.

25. The system of claim 24, wherein said plurality of transaction activities comprises at least one of an automated shipment and a shipment tracking.

26. The system of claim 25, wherein said set of predefined rules includes a checklist of transaction activities.

27. A method for selling goods and services on an online auction site, comprising:
implementing predetermined rules related to post-auction activities;
creating templates for communicating with bidders;
capturing bid characteristics from the online auction site with a single action; and
creating communications without human intervention from the bid characteristics, templates, and predetermined rules.

28. The method of claim 27, further comprising:
performing financial calculations including a tax and a shipping charge.

29. The method of claim 27, further comprising:
sending communications without human intervention in accordance with the predetermined rules.

30. The method of claim 27, further comprising:
receiving a payment from an online payment service.
